(19) United States
(12) Patent Application Publication
(10) Pub. No.: US 2007/0017084 A1
(43) Pub. Date: Jan. 25, 2007

(54) Manufacturing method for a composite striking plate of a golf club head

(75) Inventor: Chun-Yung Huang, Kaohsiung Hsien (TW)

Correspondence Address: BIRCH STEWART KOLASCH & BIRCH, PO BOX 747, FALLS CHURCH, VA, 22040-0747, US

(73) Assignee: NELSON PRECISION CASTING CO., LTD

(21) Appl. No.: 11/186,791

(22) Filed: Jul. 22, 2005

(51) Int. Cl. B23P 25/00

(52) U.S. Cl. 29/458; 29/514

(57) ABSTRACT

A manufacturing method for a composite striking plate includes the steps of: preparing a faceplate and an adapter plate; joining the faceplate and the adapter plate in heating and rolling processes to form the composite striking plate; and welding the adapter plate of the composite striking plate to a golf club head body to form a golf club head.

### BACKGROUND OF THE INVENTION

1. Field of the Invention

The present invention relates to a manufacturing method for a composite striking plate of a golf club head. Particularly, the present invention relates to the manufacturing method for the composite striking plate of the golf club head constructed from a composite metal plate which consists of a faceplate and an adapter plate made from heterogeneous metals in heating and rolling processes.

2. Description of the Related Art

Taiwanese Patent Publication No. 550,106, entitled “joining method for a golf club head,” discloses the following steps:
1. Preparing a first metal plate and a second metal plate made from a first metal and a second metal which are heterogeneous metals;
2. Joining the first metal plate and the second metal plate to form a composite metal plate by explosion welding;
3. Shaping the composite metal plate into a first part (i.e. striking plate) of the golf club head having a first peripheral configuration;
4. Preparing a second part (i.e. club head body) of the golf club head having a second peripheral configuration corresponding to the first peripheral configuration of the first part of the golf club head, and the second part made from the second metal;
5. Abutting the first peripheral configuration of the first part against the second peripheral configuration of the second part; and
6. Welding the second metal of the first part to the second metal of the second part to constitute the golf club head.

The above-mentioned manufacturing method for the golf club head employs explosion welding suitable for joining heterogeneous metals such as dissimilar metals. Once welded, the composite metal plate for use in manufacturing a striking plate has a high degree of intensity in joining such that no metal layer can be easily separated from the composite metal plate of the striking plate. Referring to FIGS. 1 and 2, however, the conventional joining method using explosion welding has several drawbacks. For example, there is an irregular interfacial layer 93 unavoidably existing between a first metal plate 91 and a second metal plate 92 after explosion welding. Disadvantageously, such an irregular interfacial layer 93 may cause an uneven portion of the composite metal plate which sharply deteriorates quality of products, like striking plates for use in striking golf. In addition, when a golf ball impacts on the striking plate of the golf club head made from such a composite metal plate, a stress force resulted from striking and exerted on the striking plate cannot be smoothly transmitted to the entire structure of the striking plate due to the irregular interfacial layer 93. This may affect the striking effect of the golf club head and further reduce a useful life of the golf club head.

Furthermore, the irregular interfacial layer 93 of the composite metal plate, as explained above, may cause several poor joins between the first metal plate 91 and the second metal plate 92 after explosion welding. This practice naturally requires a large area of the metal plates in explosion welding, and obtains a limited area of good quality of the composite metal plate available for use after explosion welding. Accordingly, the cost of the composite metal plate for manufacturing in explosion welding is unavoidably increased. Hence, there is a need for improving the joining method for the conventional golf club head.

The present invention intends to provide a manufacturing method for a composite striking plate of a golf club head in heating and rolling process, wherein a composite metal plate consists of a faceplate made from a high strength alloy and an adapter plate made from iron-based or nickel-based metal. This ensures an interfacial layer of the composite metal plate having a high degree of uniformity in such a way to mitigate and overcome the above problem. Accordingly, the uniform interfacial layer can intensify a bonding strength in the composite striking plate and improve quality of the striking plate so that a useful life of the striking plate is increased. Additionally, the adapter plate of the composite striking plate has a high degree of weldability relative to the faceplate such that it can enhance compatibility of the composite striking plate to weld to a golf club head body.

### SUMMARY OF THE INVENTION

The primary objective of this invention is to provide a manufacturing method for a composite striking plate of a golf club head, wherein a faceplate and an adapter plate made from heterogeneous metals are processed by heating and rolling. Thereby, the manufacturing method can improve quality of the composite striking plate and increase uniformity of an interfacial layer of the composite striking plate.

The secondary objective of this invention is to provide the manufacturing method for the composite striking plate of the golf club head, wherein the adapter plate of the composite striking plate has a high degree of weldability relative to the faceplate. Thereby, the manufacturing method can enhance welding compatibility of the composite striking plate to a golf club head body.

Another objective of this invention is to provide the manufacturing method for the composite striking plate of the golf club head, wherein an intermetallic layer is disposed between the faceplate and the adapter plate made from heterogeneous metals for heating and rolling processes. Thereby, the manufacturing method can intensify a bonding strength in the composite striking plate.

Another objective of this invention is to provide the manufacturing method for the composite striking plate of the golf club head, wherein the adapter plate provides with an elastic deformation space for the faceplate. Thereby, the manufacturing method can improve a striking ability of the composite striking plate.

The manufacturing method for the composite striking plate in accordance with the present invention includes the steps of:

preparing a faceplate and an adapter plate;

joining the faceplate and the adapter plate in heating and rolling processes to form the composite striking plate; and

welding the composite striking plate to a golf club head body to form a golf club head.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of two metal plates processing in explosion welding in accordance with the prior art;

FIG. 2 is a schematic side view of the composite metal plate in accordance with the prior art after explosion welding;

FIG. 3 is a flow chart of a manufacturing method for a composite striking plate of a golf club head in accordance with the present invention;

FIG. 4 is an exploded schematic view of the manufacturing method for the composite striking plate of the golf club head, before joining a faceplate and an adapter plate, in accordance with a first embodiment of the present invention;

FIG. 5 is a lateral schematic view of the manufacturing method for the composite striking plate of the golf club head joining the faceplate and the adapter plate in a rolling process in accordance with the first embodiment of the present invention;

FIG. 6 is a lateral schematic view of the manufacturing method carrying out the combined faceplate/adapter plate for use in the composite striking plate of the golf club head in accordance with the first embodiment of the present invention;

FIG. 7 is a lateral schematic view of the manufacturing method removing a center portion of the adapter plate from the composite striking plate of the golf club head in accordance with the first embodiment of the present invention;

FIG. 8 is an exploded perspective view of the golf club head prepared in the manufacturing method for the composite striking plate, which is applied to an iron-type club head body in accordance with the first embodiment of the present invention;

FIG. 9 is a cross-sectional view of the golf club head of the composite striking plate connected with the iron-type club head body in the manufacturing method in accordance with the first embodiment of the present invention;

FIG. 10 is an exploded perspective view of the golf club head prepared in the manufacturing method for the composite striking plate, which is applied to a wood-type club head body in accordance with a second embodiment of the present invention; and

FIG. 11 is a cross-sectional view of the composite striking plate connected with the wood-type club head body in the manufacturing method in accordance with the second embodiment of the present invention.

### DETAILED DESCRIPTION OF THE INVENTION

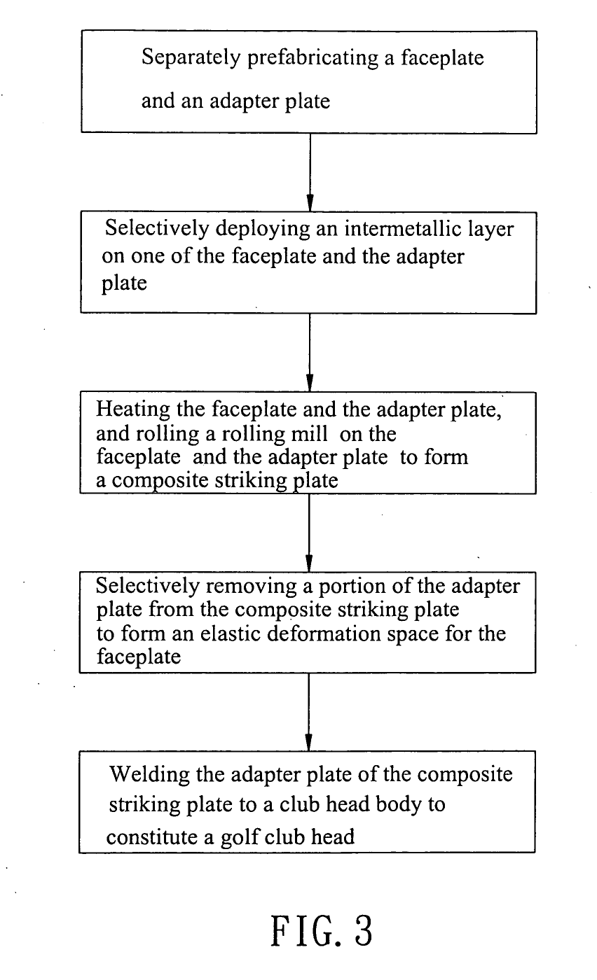

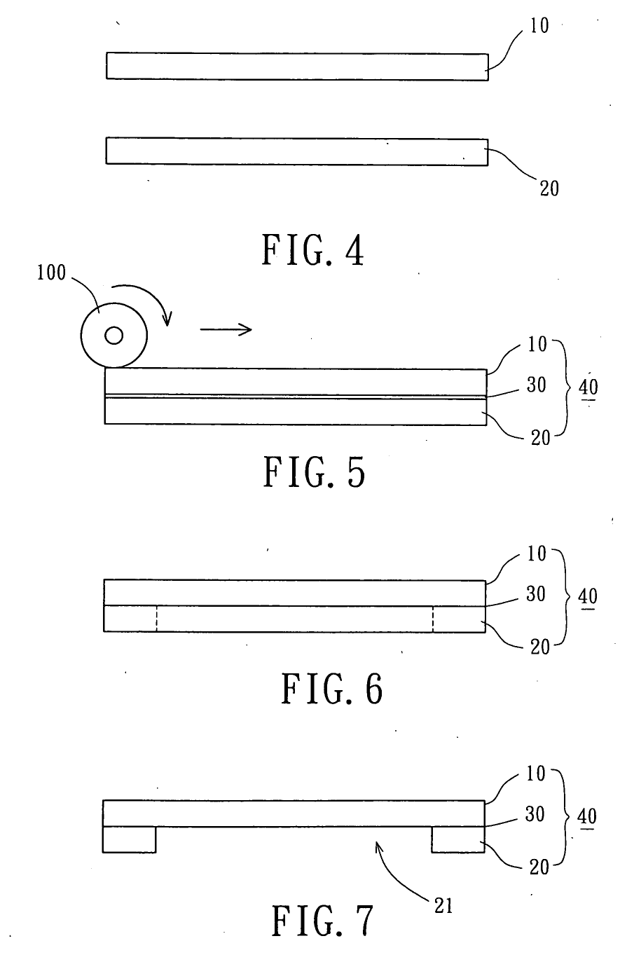

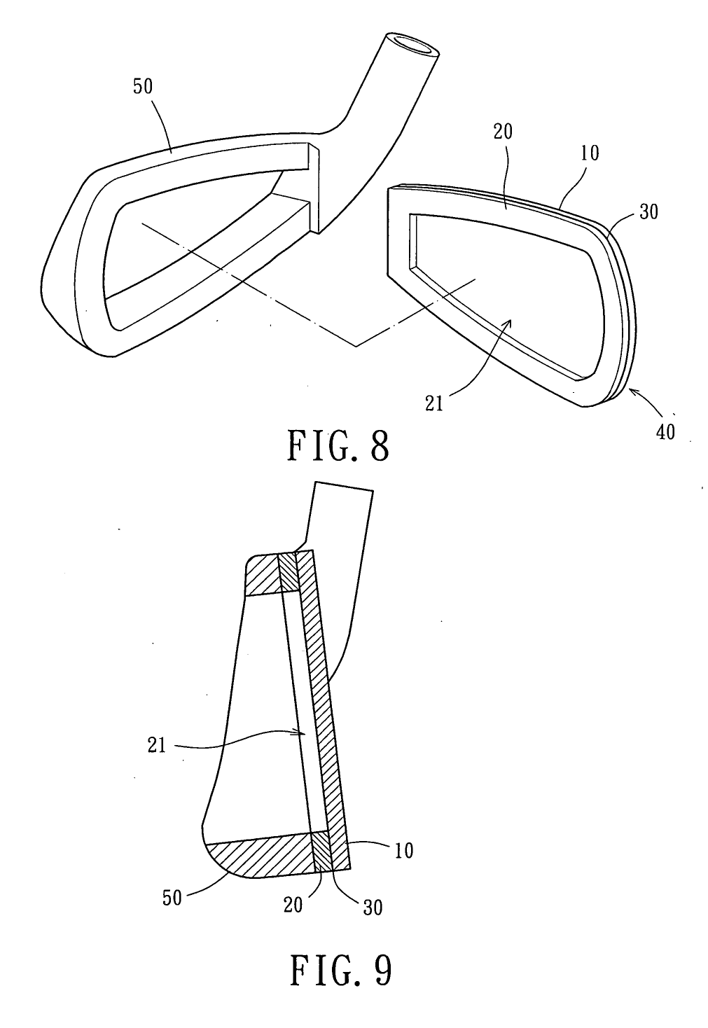

Referring to FIGS. 3 through 9, a manufacturing method for a composite striking plate of a golf club head in accordance with a first embodiment of the present invention includes the steps of:
1. Separately prefabricating a faceplate 10 and an adapter plate 20, as best shown in FIG. 4;
2. Selectively deploying an intermetallic layer 30 between the faceplate 10 and the adapter plate 20, as best shown in FIG. 5;
3. Heating the faceplate 10 and the adapter plate 20, and rolling a rolling mill 100 on the faceplate 10 and the adapter plate 20 to form a composite striking plate 40, as best shown in FIGS. 5 and 6;
4. Selectively removing a center portion of the adapter plate 20 from the composite striking plate 40 to form an elastic deformation space for the faceplate 10, as best shown in FIG. 7; and
5. Welding the adapter plate 20 of the composite striking plate 40 to an iron-type club head body 50 to constitute a golf club head, as best shown in FIG. 9.

Referring back to FIGS. 3 and 4, the first step in the manufacturing method for the composite striking plate in accordance with the first embodiment of the present invention is separately prefabricating the faceplate 10 and the adapter plate 20. Each of the faceplate 10 and the adapter plate 20 has a predetermined thickness which is strong to withstand normal usage of striking golf. The faceplate 10 is made from a metal or alloy having a high degree of strength. Preferably, the metal of the faceplate 10 is selected from a group consisting of titanium alloy, stainless steel, carbon steel, alloy steel, low-alloy steel, margining steel, aluminium alloy, magnesium alloy, copper alloy or mixtures thereof. Typically, the metal used in the faceplate 10 has poor weldability, and cannot be preferably welded to the club head body 50. In the first embodiment, the adapter plate 20 employs a metal having a good weldability greater than that of the faceplate 10. Preferably, the metal of the adapter plate 20 is selected from a group consisting of stainless steel, carbon steel, low-carbon steel, alloy steel, margining steel, cast iron, structural steel, aluminium alloy, magnesium alloy, copper alloy or mixtures thereof. The adapter plate 20 is sandwiched in between the faceplate 10 and the club head body 50. Consequently, the adapter plate 20 serves to intensify a joining strength of the faceplate 10 to the club head body 50 such that the disconnection of the face plate 10 from the club head body 50 can be avoided.

Referring back to FIGS. 3 and 5, the second step in the manufacturing method for the composite striking plate in accordance with the first embodiment of the present invention is selectively disposing the intermetallic layer 30 between the faceplate 10 and the adapter plate 20. In an alternative embodiment, the intermetallic layer 30 can be omitted according to the design choice. In the first embodiment, the intermetallic layer 30 is selectively formed on either surface of the faceplate 10 or the adapter plate 20 by electroplating, coating, physical vapor deposition, sputtering deposition or sputter ion plating. Preferably, the metal of the intermetallic layer 30 is selected from a group consisting of niobium, chromium, aluminium, copper, manganese, cobalt, zirconium, titanium, vanadium, tantalum, silver, nickel, tungsten or alloy thereof. Particularly, the metal of the intermetallic layer 30 has a degree of welding compatibility with both of the faceplate 10 and the adapter plate 20 greater than that of faceplate 10 with the adapter plate 20. Advantageously, the intermetallic layer 30 can effectively intensify a bonding strength between the faceplate 10 and the adapter plate 20.

Referring again to FIGS. 3 and 5-6, the third step in the manufacturing method for the composite striking plate in accordance with the first embodiment of the present invention is heating and rolling the faceplate 10 and the adapter plate 20 in heating and rolling processes at the same time or in sequence to form the composite striking plate 40. To improve the join between the faceplate 10 and the adapter plate 20, the faceplate 10 and the adapter plate 20 are heated and completely connected with each other. The connection between the faceplate 10 and the adapter plate 20 can be carried out by a number of methods. In the first embodiment, the rolling mill 100 exerts a strong pressing force on either side of the faceplate 10 or the adapter plate 20. In this embodiment, the rolling mill 100 can gradually move along a direction (as shown an arrow in FIG. 5) from one end to another of the faceplate 10 by means of rotation, and the faceplate 10 and the adapter plate 20 are joined in the event. After the rolling process, the faceplate 10, the adapter plate 20 and the intermetallic layer 30 can serve as a “hybrid” one-piece member and consist in the composite striking plate 40. In this embodiment, the composite striking plate 40 is suitable for constructing a part of the golf club head, and striking a golf ball (not shown) since the adapter plate 20 has a preferred weldability and the faceplate 10 has a preferred rigid. The intermetallic layer 30, as such, can form a uniform interfacial layer between the faceplate 10 and the adapter plate 20, and intensify a highly bonding strength therebetween.

Referring again to FIGS. 3 and 6 and 7, the fourth step in the manufacturing method for the composite striking plate in accordance with the first embodiment of the present invention is selectively removing a center portion of the adapter plate 20 from the composite striking plate 40 to form an elastic deformation space 21 for the faceplate 10. In an alternative embodiment, the elastic deformation space formed in the adapter plate 20 can be omitted according to the design choice. In the first embodiment, an inner periphery of the adapter plate 20 delimits the elastic deformation space 21 which corresponding to a sweet spot area of the faceplate 10. Preferably, the elastic deformation space 21 as well as a rear cavity of the composite striking plate 40 can be formed by removing the center portion of the adapter plate 20 in one of etching, grinding, chemical treating and milling processes. Consequently, the elastic deformation space 21 can improve a striking ability of the composite striking plate 40.

Referring again to FIGS. 3, 8 and 9, the fifth step in the manufacturing method for the composite striking plate in accordance with the first embodiment of the present invention is welding the composite striking plate 40 to the iron-type club head body 50 to constitute the iron-type golf club head. Typically, the iron-type club head body 50 consists of common forms of a toe portion, a blade portion, a heel portion and a sole portion etc. Furthermore, a hosel is formed on the heel portion of the club head body 50. In the first embodiment, the club head body 50 is made from a metal similar to that of the adapter plate 20 for the sake of welding compatibility. Preferably, the metal of the club head body 50 is selected from a group consisting of stainless steel, carbon steel, low-carbon steel, alloy steel, low-alloy steel, margining steel, cast iron, structural steel, aluminium alloy, magnesium alloy, copper alloy or mixtures thereof. More preferably, the club head body 50 can be selectively constructed in casting, forging or machining. To accomplish the combination of the composite striking plate 40 with the club head body 50, an outer periphery of the adapter plate 20 is mechanically connected with a front-end edge of the club head body 50 by preferably selecting ordinary welding or brazing. In an alternative embodiment, the club head body 50 has an annular protrusion (not shown) formed on the front-end edge for compensating a metal material in the following welding process.

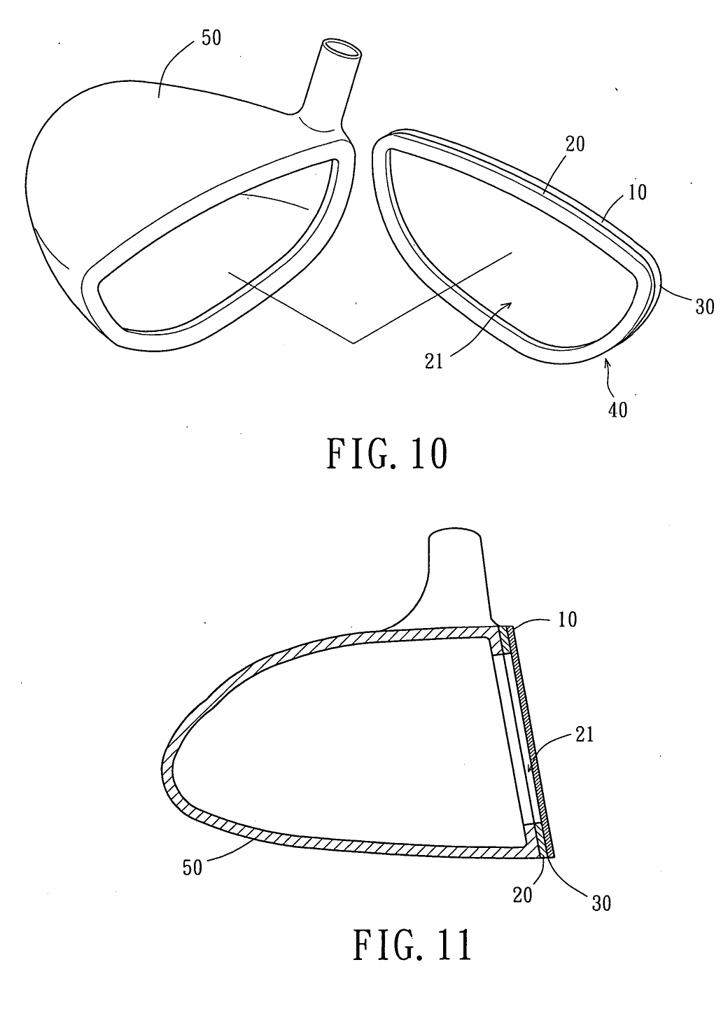

Turning now to FIGS. 3 and 10 and 11, the manufacturing method for the composite striking plate in accordance with the second embodiment of the present invention has the same method of the first embodiment. In comparison with the first embodiment, the manufacturing method in accordance with the second embodiment is applied to a wood-type club head body. In an alternative embodiment, the manufacturing method can be applied to a utility club head body. Similarly, the adapter plate 20 of the composite striking plate 40 employs a metal having a good weldability greater than that of the faceplate 10. Consequently, the adapter plate 20 of the composite striking plate 40 serves to intensify a joining strength of the composite striking plate 40 to the club head body 50. Furthermore, the metal of the wood-type club head body 50 is preferably selected from a group consisting of stainless steel, carbon steel, low-carbon steel, alloy steel, margining steel, cast iron, structural steel, aluminium alloy, magnesium alloy, copper alloy or mixtures thereof.

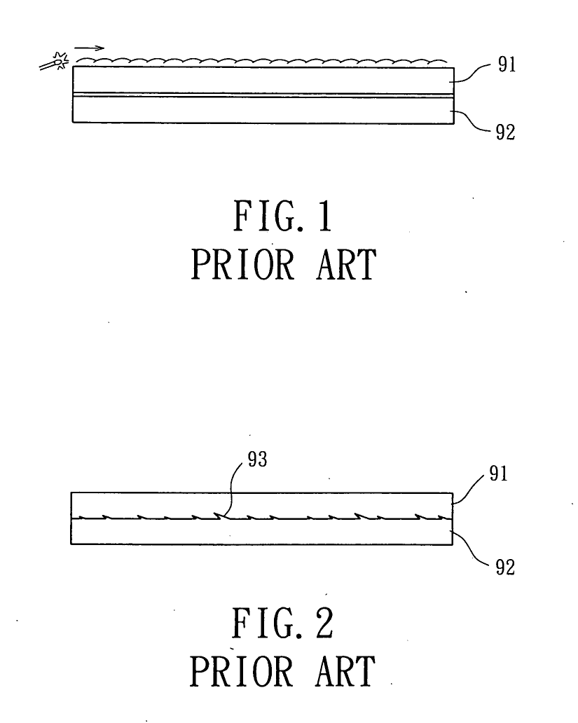

As has been discussed above, the conventional manufacturing method for the composite metal plate of the striking plate, as shown in FIGS. 1 and 2, employs explosion welding for joining heterogeneous metals, and disadvantageously forms an irregular interfacial layer. Conversely, the manufacturing method for the composite striking plate in accordance with the present invention, as shown in FIG. 3, can join heterogeneous metals of the faceplate 10 and the adapter plate 20 to form the composite striking plate 40 in heating and rolling processes. Consequently, the adapter plate 20 of the composite striking plate 40 can enhance welding compatibility of the composite striking plate 40 to the golf club head body 50, and improve a striking ability of the composite striking plate 40.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A manufacturing method for a golf club head, comprising the steps of:
preparing a faceplate and an adapter plate;
joining the faceplate and the adapter plate in a heating and rolling process to form a composite striking plate; and
welding the adapter plate of the composite striking plate to a golf club head body to form the golf club head.

2. The manufacturing method for the golf club head as defined in claim 1, wherein heating the faceplate and the adapter plate prior to carrying out the rolling process.

3. The manufacturing method for the golf club head as defined in claim 1, wherein disposing an intermetallic layer between the faceplate and the adapter plate prior to carrying out the rolling process.

4. The manufacturing method for the golf club head as defined in claim 3, wherein removing a portion of the adapter plate to form an elastic deformation space for the faceplate subsequent to the rolling process.

5. The manufacturing method for the golf club head as defined in claim 4, wherein the elastic deformation space being formed on the adapter plate in one of etching, grinding, chemical treating and milling processes.

6. The manufacturing method for the golf club head as defined in claim 1, wherein the golf club head body being selected from an iron-type club head body, a wood-type club head body or a utility club head body.

7. The manufacturing method for the golf club head as defined in claim 1, wherein the faceplate being made from a metal selected from a group consisting of titanium alloy, stainless steel, carbon steel, alloy steel, low-alloy steel, margining steel, aluminium alloy, magnesium alloy, copper alloy or mixtures thereof.

8. The manufacturing method for the golf club head as defined in claim 1, wherein the adapter plate employing a metal having a weldability greater than that of the faceplate.

9. The manufacturing method for the golf club head as defined in claim 8, wherein the adapter plate being made from a metal selected from a group consisting of stainless steel, carbon steel, low-carbon steel, alloy steel, margining steel, cast iron, structural steel, aluminium alloy, magnesium alloy, copper alloy or mixtures thereof.

10. The manufacturing method for the golf club head as defined in claim 1, wherein the golf club head body being made from a metal selected from a group consisting of stainless steel, carbon steel, low-carbon steel, alloy steel, margining steel, cast iron, structural steel, aluminium alloy, magnesium alloy, copper alloy or mixtures thereof.

11. The manufacturing method for the golf club head as defined in claim 3, wherein the intermetallic layer being selectively formed on either surface of the faceplate or the adapter plate by electroplating, coating, physical vapor deposition, sputtering deposition or sputter ion plating.

12. The manufacturing method for the golf club head as defined in claim 3, wherein the intermetallic layer being made from a metal selected from a group consisting of niobium, chromium, aluminium, copper, manganese, cobalt, zirconium, titanium, vanadium, tantalum, silver, nickel, tungsten or alloy thereof.

13. A manufacturing method for a composite striking plate of a golf club head, comprising the steps of:
preparing a faceplate and an adapter plate;
joining the faceplate and the adapter plate in heating and rolling processes to form a composite laminate; and
cutting the composite laminate to have a configuration of the composite striking plate corresponding to a front opening of the golf club head body.

14. The manufacturing method for the composite striking plate of the golf club head as defined in claim 13, wherein heating the faceplate and the adapter plate prior to carrying out the rolling process.

15. The manufacturing method for the composite striking plate of the golf club head as defined in claim 13, wherein disposing an intermetallic layer between the faceplate and the adapter plate prior to carrying out the rolling process.

16. The manufacturing method for the composite striking plate of the golf club head as defined in claim 13, wherein removing a portion of the adapter plate to form an elastic deformation space for the faceplate subsequent to the rolling process.

17. The manufacturing method for the composite striking plate of the golf club head as defined in claim 16, wherein the elastic deformation space being formed on the adapter plate in one of etching, grinding, chemical treating and milling processes.

18. The manufacturing method for the composite striking plate of the golf club head as defined in claim 13, wherein the faceplate being made from a metal selected from a group consisting of titanium alloy, stainless steel, carbon steel, alloy steel, low-alloy steel, margining steel, aluminium alloy, magnesium alloy, copper alloy or mixtures thereof.

19. The manufacturing method for the composite striking plate of the golf club head as defined in claim 13, wherein the adapter plate employing a metal having a weldability greater than that of the faceplate.

20. The manufacturing method for the composite striking plate of the golf club head as defined in claim 19, wherein the adapter plate being made from a metal selected from a group consisting of stainless steel, carbon steel, low-carbon steel, alloy steel, margining steel, cast iron, structural steel, aluminium alloy, magnesium alloy, copper alloy or mixtures thereof.

21. The manufacturing method for the composite striking plate of the golf club head as defined in claim 15, wherein the intermetallic layer being selectively formed on either surface of the faceplate or the adapter plate by electroplating, coating, physical vapor deposition, sputtering deposition or sputter ion plating.

22. The manufacturing method for the composite striking plate of the golf club head as defined in claim 15, wherein the intermetallic layer being made from a metal selected from a group consisting of niobium, chromium, aluminium, copper, manganese, cobalt, zirconium, titanium, vanadium, tantalum, silver, nickel, tungsten or alloy thereof.
